(19) United States
(12) Patent Application Publication
(10) Pub. No.: US 2021/0133828 A1
(43) Pub. Date: May 6, 2021

(54) METHOD AND APPARATUS FOR MARKETING USING ONLINE PREDICTIONS BASED ON PRESTORED SURVEYS

(71) Applicant: Tastepals Ltd., Bnei-Brak (IL)

(72) Inventor: Daniel LEHMANN, Jerusalem (IL)

(73) Assignee: Tastepals Ltd., Bnei-Brak (IL)

(21) Appl. No.: 16/872,425

(22) Filed: May 12, 2020

Related U.S. Application Data
(60) Provisional application No. 62/930,649, filed on Nov. 5, 2019.

(51) Int. Cl. G06Q 30/02; G06F 16/957; H04L 29/08

(52) U.S. Cl. CPC G06Q 30/0282; G06Q 30/0203; H04L 67/06; G06F 16/957; G06Q 30/0205

(57) ABSTRACT

A method of remote surveying to forecast popularity of a product or a media item comprises showing the item to a first, statistically significant and representative, sample of people, items of a closed catalog, obtaining a rating of each catalog item, and storing the ratings. Then a second, smaller, sample that is not representative of the population is shown the product or media item needing the forecast along with the items of the catalog. The people in the second sample rate the products or items in the same way and then a pseudo-distance is calculated between the catalog items and the product or media item. The pseudo-distance is applied to each person in the first sample to obtain a personal pseudo-rating for the product or media item. The personal pseudo-ratings provide a statistically significant electronic indicator of reactions to the product or media item.

### RELATED APPLICATION(S)

This application claims the benefit of priority under 35 USC § 119(e) of U.S. Provisional Patent Application No. 62/930,649 filed on Nov. 5, 2019, the contents of which are all incorporated by reference as if fully set forth herein in their entirety.

### FIELD AND BACKGROUND OF THE INVENTION

The present invention, in some embodiments thereof, relates to an apparatus and method for marketing based on online predictions regarding the popularity of and public reaction to a product or a media item.

Market surveys are an essential tool for choosing the final specification and presentation of a product, for deciding on a target audience and for implementing a sales strategy. To this purpose a panel is assembled and demographic information about its members, such as: age, gender, location, education, occupation, hobbies, income, purchases, social environment and many other questions of interest to whoever requested the survey, is assembled. This information is referred to hereinbelow as profile information, and each panel member has such a profile, which may be as sparse or as detailed as desired.

The product, or the different possible versions of the product, are presented and the panel members reactions are elicited.

Following is a sample of the questions that can be answered based on the information gathered from the panel. How successful will the product be, or which version of the product will be more successful? How does the product compare with other products? Which part of the population is most likely to buy the product: young people or old people, males or females, active, retired or unemployed, rich or poor, and so on? What is the best marketing plan: aiming at a large heterogeneous crowd or a narrow target? Is there another product that elicits reactions very similar to those elicited by the product and from which one could learn more?

It is to be noted that the survey is not limited to products. Media items, say connected to planned advertising promotions, or to political campaigns, may also be tested in advance using panels and surveys.

The panel needs to be representative of the target population, in order for the members reactions to be representative of those of the public at large. The larger the panel, the more reliable the aggregated reactions of its members. The whole process of gathering a large enough representative panel and eliciting its reactions is quite expensive and time-consuming. It is typically delegated to professional agencies specialized in market surveys.

Recently, on-line panels have gained in popularity and a number of companies specialize in organizing such on-line panels.

Over recent decades, recommendation systems have significantly improved. Such systems are capable of choosing, from a catalog of products, the products that best fit the individual taste of a client, based on a small sample of the client's taste. One of the recommendation technologies that is best suited for this purpose has been described in U.S. Pat. Nos. 7,075,000 and 7,102,067 to the present inventor, the contents of which are hereby incorporated by reference in their entirety, but other recommendation methods can be used. At least any recommendation method that evaluates how much an individual user is predicted to like each item of the catalog can be used. Such are all the recommendation methods described in the patents above. The Song Map method, of the item-to-item family, described there is the one that provides the most accurate predictions of the attraction each item of a catalog of items will exert on each member of a panel.

In U.S. Pat. No. 7,102,067, a user is played a catalog of musical items and asked to rate them. The items in the catalog are categorized with internal characteristics of the music, and then recommendations of other items not in the original rating are made based on the internal characteristics weighted according to the user's ratings to recommend further musical items from the catalog.

U.S. patent application Ser. No. 14/202,093 discloses a system and method for estimating preferences or taste of users comprises a catalog having a closed number of items; a memory for storing distances between ratings of each pair of items; and a user interface to rate a subset of the items. The distances from the subset items to other items of the catalog give the user a preference for each item in the catalog despite never having rated these items. The catalog is ordered using the assigned preferences into a user preference vector, and is compared with vectors of other users to match up different users having similar preferences. Alternatively, a distance measure can be defined between preferences of different users, with matching made between the users having the smallest difference. Initial distances may come from rating by a focus group or from application download data or other suitable sources. The end result is that the current user obtains recommendations but with the improvement that different users with similar preferences may be grouped together, say to send similar recommendations to different members of the group.

However, the above prior art only provides a recommendation for an individual. That is to say it is person based, not product-based. It does not say anything about popularity of an item in general, nor does it say anything about the kind of person who would like that item.

One approach to determine general popularity of an item would be to show or play that item to a large number of people. However statistical significance is needed, and the group needs to be selected to be representative of a population as a whole. It is costly to get a large and representative sample to take part in a survey each time.

### SUMMARY OF THE INVENTION

The present embodiments attempt to use an Internet-based method to obtain popularity results on a product, item of music, item for a campaign etc., that has a validity associated with a large-scale survey but without the need to survey a large number of people each time.

This may be achieved by providing an initial survey of a large number of people who rate items in a very general catalog. Then each product is rated by a smaller number of people, and these people also rate the items in the very large catalog. The small group provides a correlation between a rating of the product and ratings of the catalog items, a pseudo-distance as discussed hereinbelow, and then ratings of the product based on the pseudo-distance are attributed to all of the members of the larger group, so as to give a statistically valid view of the product etc., which is personal, that is to say contains personal views of a large number of people in a statistically valid way even though most of the people concerned have never rated or even seen the product or media item concerned.

From then on, the characteristics of the individuals in the larger group giving higher ratings to the product may indicate the kind of person interested in the product. According to an aspect of some embodiments of the present invention there is provided a method of remote surveying to forecast popularity of a product or a media item comprising:

Electronically generating a closed catalog of items, the items being products or media items, the items being stored as files in electronic media;

Over a network, obtaining a first sample of people that are representative of a population and statistically significant;

Electronically sending to each person of the first sample at least some of the files, and showing or playing the files for a predetermined interval at a terminal device of each the person of the first sample;

Electronically obtaining from each person of the first sample a rating of each catalog item shown or played;

Electronically storing the ratings; Over the network obtaining a second sample of people, the second sample being smaller than the first sample such that the second sample is not representative of the population;

Electronically sending to persons of the second sample files representative of the product or media item whose forecast is required along with respective files of the items of the catalog and showing the files on a respective terminal device for the predetermined amount of time;

Electronically obtaining from each person of the second sample ratings of the product or media item and of each catalog item;

From the second sample, calculating a pseudo-distance between respective catalog items and the product or media item; Using the pseudo-distance, applying to each person of the first sample a personal pseudo-rating for the product or media item, and

Outputting the personal pseudo-ratings as a statistically significant electronic indicator of reactions to the product or media item.

An embodiment may comprise:

Aggregating the personal pseudo-ratings to obtain an aggregated rating for the product or media item, the aggregated rating thereby having statistical significance; and

Outputting the aggregated rating as an electronically derived product rating.

An embodiment may comprise applying clustering to persons of the first sample based on the pseudo-ratings and profile information of the persons to obtain a generalized profile of one member of the group comprising: persons in approval of the product and persons not in approval of the product.

In an embodiment, the electronically showing is carried out using an electronic screen, the product or media item being shown on the screen for the predetermined amount of time followed by an interval for receiving a rating.

In an embodiment, each person of the first sample is shown a random selection of items of the catalog, and each person of the second sample is shown all of the items of the catalog.

In an embodiment, the catalog is limited to products or media items, which are screen-suitable for online viewing.

An embodiment may comprise storing the closed catalog on a server and carrying the electronically showing and electronically obtaining from at least some of the people of the second sample via respective mobile telephones.

An embodiment may comprise storing the closed catalog on a server and carrying the electronically showing and electronically obtaining from at least some of the people of the first sample via respective mobile telephones.

An embodiment may comprise providing forecasts for a plurality of additional products or media items and then grouping the products according to similarities in respective generalized profiles.

An embodiment may comprise normalizing ratings of different persons of the first sample.

In an embodiment, the files of the catalog items are sent individually over the network for the showing.

In an embodiment, the files of the catalog items are streamed over the network for the showing.

An embodiment may comprise uploading electronic media relating to the product whose forecast is required over the network.

The method may be cloud-based, or server-based.

In an embodiment, respective terminal devices of the second sample are mobile devices with location ability, the second sample being selected according to a currently obtained location.

The method may comprise aggregating results for a set of products.

According to a second aspect of the present invention there is provided an application for use at respective terminal devices configured for use with a method of remote surveying to forecast popularity of a product or a media item, the method comprising:

Electronically generating a closed catalog of items, the items being products or media items, the items being stored as files in electronic media;

Over a network, obtaining a first sample of people that are representative of a population and statistically significant;

Electronically sending to each person of the first sample at least some of the files, and showing or playing the files for a predetermined interval at a terminal device of each the person of the first sample;

Electronically obtaining from each person of the first sample a rating of each catalog item shown or played;

Electronically storing the ratings; Over the network obtaining a second sample of people, the second sample being smaller than the first sample such that the second sample is not representative of the population;

Electronically sending to persons of the second sample files representative of the product or media item whose forecast is required along with respective files of the items of the catalog and showing the files on a respective terminal device for the predetermined amount of time;

Electronically obtaining from each person of the second sample ratings of the product or media item and of each catalog item;

From the second sample, calculating a pseudo-distance between respective catalog items and the product or media item;

Using the pseudo-distance, applying to each person of the first sample a personal pseudo-rating for the product or media item, and

Outputting the personal pseudo-ratings as a statistically significant electronic indicator of reactions to the product or media item;

The application interacting with the method to carry out the showing or playing the files for a predetermined interval at the terminal device and electronically obtaining corresponding ratings.

According to a third aspect of the present invention there is provided server for use in a method of remote surveying to forecast popularity of a product or a media item, the method comprising:

Electronically generating a closed catalog of items, the items being products or media items, the items being stored as files in electronic media;

Over a network, obtaining a first sample of people that are representative of a population and statistically significant;

Electronically sending to each person of the first sample at least some of the files, and showing or playing the files for a predetermined interval at a terminal device of each the person of the first sample;

Electronically obtaining from each person of the first sample a rating of each catalog item shown or played;

Electronically storing the ratings;

Over the network obtaining a second sample of people, the second sample being smaller than the first sample such that the second sample is not representative of the population;

Electronically sending to persons of the second sample files representative of the product or media item whose forecast is required along with respective files of the items of the catalog and showing the files on a respective terminal device for the predetermined amount of time;

Electronically obtaining from each person of the second sample ratings of the product or media item and of each catalog item;

From the second sample, calculating a pseudo-distance between respective catalog items and the product or media item;

Using the pseudo-distance, applying to each person of the first sample a personal pseudo-rating for the product or media item, and

Outputting the personal pseudo-ratings as a statistically significant electronic indicator of reactions to the product or media item;

The server configured to store the catalog, send data of the catalog to the first sample, and to send data of the catalog and the product or media item to the second sample, to receive respective ratings, to calculate respective pseudo-distances and provide the output.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flow chart showing a method according to an embodiment of the present invention;

FIG. 2 is a continuation of FIG. 1 showing product oriented and person-oriented results;

FIG. 3 is a block diagram showing the hardware on which an embodiment of the present invention may operate;

FIG. 4 is a simplified diagram showing a correlation between prediction and measured rating obtained using an embodiment of the present invention;

FIG. 5 is a simplified diagram showing an appreciation factor obtained for a given product using the present embodiments;

FIG. 6 is a simplified diagram showing how four products are shown by the present embodiments to attract the same panelist segments as a selected product;

FIG. 7 is a table describing personality features indicated by the present embodiments for a number of products, in which each column corresponds to a product and each row corresponds to a segment of the panelists population; and

FIG. 8 illustrates the sort of personality interested in a beauty product as revealed using the present embodiments.

### DESCRIPTION OF SPECIFIC EMBODIMENTS OF THE INVENTION

The present invention, in some embodiments thereof, relates to an apparatus and method for online predictions regarding the popularity of a product or a media item. A method of remote surveying to forecast popularity of a product or a media item according to the present embodiments comprises showing to a first, statistically significant and representative, sample of people, items of a closed catalog, obtaining a rating of each catalog item, and storing the ratings. Then a second, smaller, sample that is not representative of the population is shown the product or media item needing the forecast along with the items of the catalog. The people in the second sample rate the products or items in the same way and then a pseudo-distance is calculated between the catalog items and the product or media item. The pseudo-distance is applied to each person in the first sample to obtain a personal pseudo-rating for the product or media item. The personal pseudo-ratings provide a statistically significant electronic indicator of reactions to the product or media item.

More particularly, the goal of a market survey is to gather information about the potential success of a typically new product, how successful is it likely to be? How can the persons most likely to buy it be characterized? What will the best packaging be? What will the best marketing strategy be?

Conducting a market survey traditionally requires gathering a group of people (a panel) that well represents the target audience, show the product in question to each panel member and record their reactions. Such an operation is difficult, because the panel must be representative, costly, because the panel must be large, and lengthy, because each panelist must be presented with the product and his reactions be recorded.

The present embodiments may perform market surveys that are based on the predicted reactions of the panel members and therefore does not require any of the members of the panel to actually be presented with the product. Panel members are presented, just once with a test that reveals their individual taste, in the wider sense, and the results of this test may enable a computer programmed to carry out the present embodiments to predict their immediate attraction to or repulsion from items that have not been presented to them. Panel members may complete a demographic questionnaire about many of their individual characteristics and habits to provide enhanced profiles. The profile information may be rich enough so that the methods of the present embodiments may use that information to enable an accurate prediction about the reaction of each panel member to a product without having to show the product to him. As a consequence one can mutualize the effort, the cost and the time required for conducting a market survey. The price paid is that a market survey based on predicted reactions will be less accurate than a traditional survey, but this can be overcome by using a somewhat larger panel since the panel is gathered only once. The present application builds on a first summary description of a method that is contained in Section 10—Analytics—of provisional application No. 61/775,506 filed on Mar. 10, 2013, and on the similar method in Section [0096]—Analytics—of patent application Ser. No. 14/202,093 filed Mar. 10, 2014, the contents of which are incorporated herein by reference.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

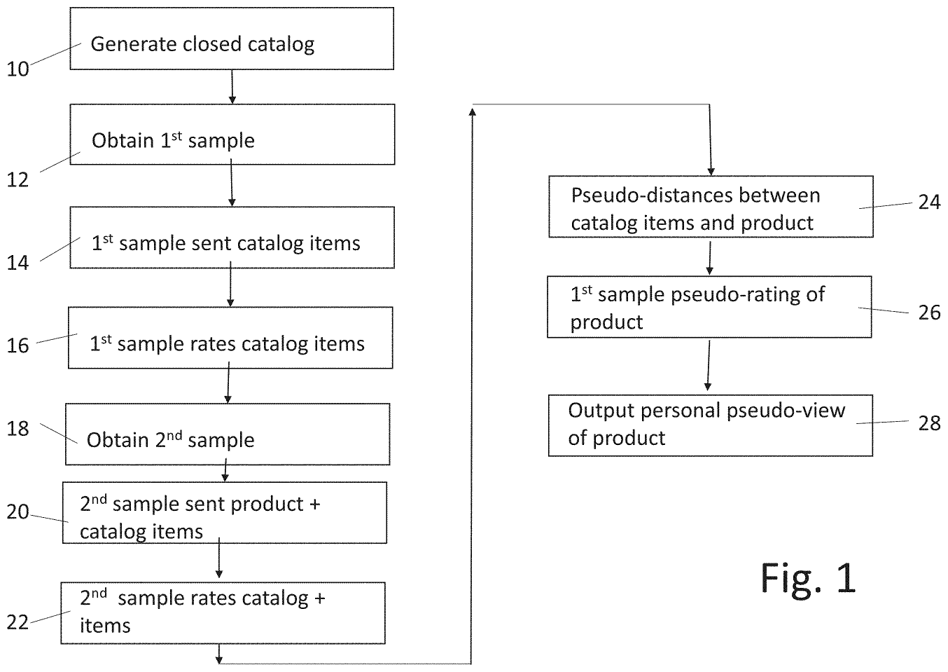

Reference is now made to FIG. 1, which is a simplified flow chart illustrating a method of remote surveying to forecast popularity of a product or a media item according to an embodiment of the present invention. As illustrated in FIG. 1, the method initially involves—box 10 —electronically generating a closed catalog of items. The items are for example products or media items and are designed to fit a range of interests and to elicit responses from different kinds of people. Accordingly, the number of items in the catalog may be relatively large, that is in the order of magnitude of hundreds. An idea behind the size of the catalog is that there should be responses that are relevant for any product that might later need a forecast. The construction of the catalog is discussed in greater detail hereinbelow but it is here noted that the catalog is made up of visual or audible items that can easily be shown or played over a network. The items in the catalog are items that can provide a file that is transferable over the network and can then be played to the recipient and judged in a very short time frame, around five seconds or so.

Over a network, a first sample is obtained. The sample is of people that are representative of a population and the sample needs to be statistically significant. Preferably the sample is large enough that the more significant sub-groups in the population have statistically significant representation, although the larger the sample the greater the cost. Statistical significance may be defined by a confidence level and a corresponding z-score. Alternatively the Student-T distribution may be used if the parameters of the distribution are unknown. Thus, a 90% confidence level may give a Z-score of 1.645 and a 95% confidence level may give a Z-score of 1.96. A 99% confidence level gives a Z-score of 2.576. The sample size may then be computed based on the required confidence level and the statistical deviation.

Then the statistically significant sample size is

(Z-score)²*StdDev*(1−StdDev)/(margin of error)²

Thus, assuming you chose a 95% confidence level, a 0.5 standard deviation, and a margin of error (confidence interval) of +/−5%. ((1.96)2×0.5(0.5))/(0.05)2=384.16 so that 385 respondents are needed to provide a statistically significant sample under these circumstances. It is to be noted that if statistically significant results are required from sub-groups of the population, then each sub-group must have a statistically significant representation. Thus if results say for males and females separately are to be statistically significant then each of these groups must be in statistically significant numbers.

Each person in the first sample is then sent, one by one, a media item for each catalog entry, and the item is shown or played—box 14—on the user's electronic device, via a screen or audio or both as relevant, for a predetermined interval. The process is repeated for each of the items of the closed catalog. The item is shown as a media item and is played for a preset amount of time, for example five seconds and the person is required to rate the item using his/her electronic device—box 16. The method proceeds by electronically obtaining that rating from the sample member.

The catalog ratings of the first sample are then stored.

Later, at some time, a product requires a survey. At this point, a smaller sample of people is obtained—box 18. The smaller, second, sample is cheaper to organize, and it is noted that the smaller sample does not have to be representative of the population, or have statistically significant sub-groups. In embodiments, the full sample may not be of statistical significance, but would be relatively stable if every member of the group is shown each of the catalog items.

The same procedure of providing catalog items is carried out with the second sample, with the addition of the new product. The second sample is provided with and shown the product or media item whose forecast is required along with the items of the catalog—box 20—and ratings are obtained in return in the same way, using the same preset time interval for each rating—box 22. In an embodiment, the persons in the first sample, the panelists, may each be shown just a random selection of the catalog rather than the whole catalog. Again, the media items to be shown are sent one by one as media files, or streamed, to the recipient, and played for the preset amount of time, to allow the recipient to return a rating.

From the results of the second sample, a pseudo-distance is calculated between respective catalog items and the product or media item—box 24, as will be discussed in greater detail below. Consider a catalog item X and a product P. Each member of the second sample, ie., each rater, has rated item X and product P, the difference (absolute difference) between the grades given to X and to P can be considered as a pseudo-distance given by the rater to the pair (X, P). The average of those pseudo-distances evaluated by each of the raters can be seen as a pseudo-distance representing the collective evaluation of the distance separating X and P.

The prestored ratings of the 1^{st} sample are then retrieved from storage, and are applied to the pseudo-distances, so that each person in the first sample provides a personal pseudo-rating for the product or media item. That is to say, each person in the first sample gives a rating to the product, even though he or she has never seen the item. For example if the product has pseudo-distance 1.5 from catalog item X and pseudo distance 1 from catalog item Y, and a rater has rated catalog item X as 3 and catalog item Y as 1 as well, then his personal rating for the product is the average of (3/1.5) and (1/1) which gives 3. Of course, this is greatly simplified and there are hundreds of pseudo-distances not two.

At this point—box 28—the system output is a series of personal pseudo-ratings of the product. These pseudo-ratings may provide a statistically significant electronic indicator of reactions to the product or media item.

In one embodiment, the second sample is selected according to current location as indicated by the location ability of their mobile telephones. For example, a retail product may benefit from a focus group made up of people determined to be within a shopping area.

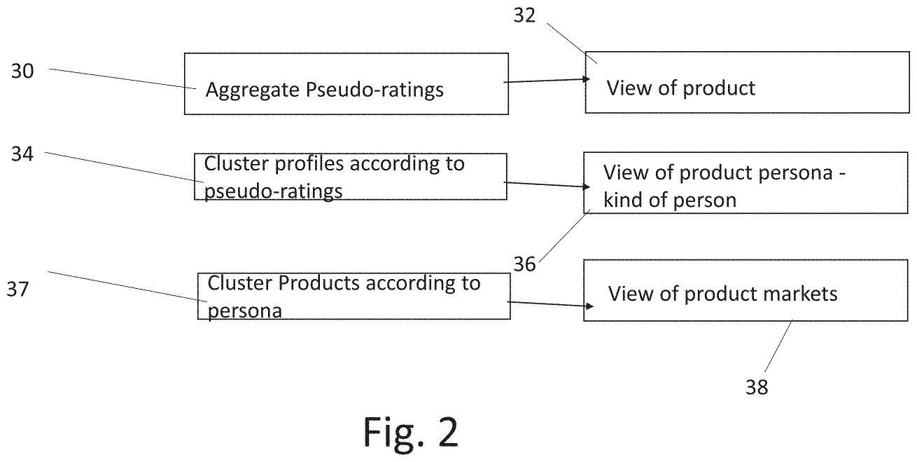

Referring now to FIG. 2, which is a continuation of FIG. 1, the personal pseudo-ratings may be aggregated—box 30—to obtain an overall aggregated rating for the product or media item if that is what is required. The aggregated rating may thus have statistical significance and may indicate the popularity of the product over the public as a whole. The aggregated rating may then be output as an electronically derived product rating and provide information that is product centered—box 32.

Additionally, or alternatively, the method may apply clustering to persons in the first sample based on their pseudo-ratings and profile information—box 34. The result is a person view of the product or media item, what kind of person would be interested or not interested in it—box 36. For example, the product or media item may be shown to produce positive feelings from females between ages 18 and 30 but negative feelings from males between 55 and 65.

For example, the method may find all persons whose pseudo-rating for the product is above 4. It may then consider the profile information of all these persons and discover that 60% of them are below the age of 30 and also that 95% are female. The method thus provides a profile of female and below the age of 30 to look for as someone likely to approve of the product. Again, the result is statistically significant since the number of persons in the first sample is statistically significant, even if no statistically significant number of persons ever rated the product directly.

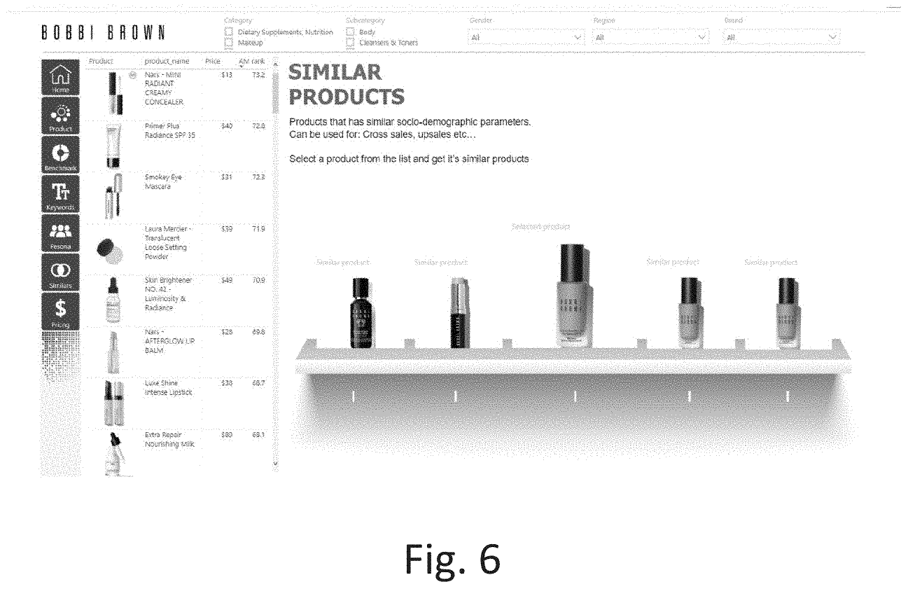

Several products may be rated, and then products whose personalities are the same or similar may be grouped together or clustered together—box 37 to give a group of products or media items that may interest the same kinds of people—box 38. The groups of products may then be considered as separate markets to be addressed individually. The grouping of products will be discussed below in greater detail with respect to FIG. 6.

In the same way, the popularity of a group of products, e.g., a brand, may be assessed by averaging on the products in the group

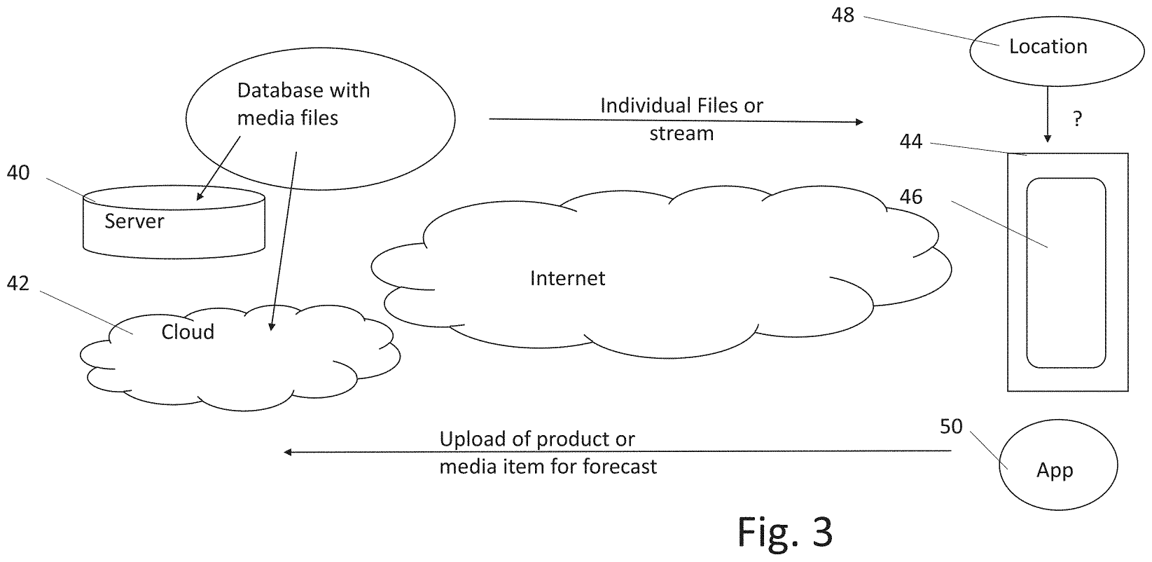

Referring to FIG. 3, the catalog data may be kept as a database in a server 40 or in the cloud 42 and the database items are either sent as individual media files or as a stream put together from the media files. The end user generally interacts with the data using a personal computing device, which has a screen and/or audio. The personal computing device may be any suitable networked computing device 44 having a screen 46, including a mobile telephone, a tablet, a laptop and a desktop computer. Some of these devices, for example the mobile telephone, may be able to provide location information 48, which can be used to help select the focus group in one embodiment, as mentioned above. An app 50 may be located at the personal computing device to support use of the method. In particular, the app may recognize the media files, play the files for the preset amount of time, and provide buttons or audio listening to obtain and send back the ratings.

As mentioned, each item to be rated, whether sent individually or streamed, is shown using electronic screen 46 and audio as relevant, and is played or shown for a predetermined amount of time such as five seconds. The interval is short so that the rating is a system 1 reaction. The media item may be pure audio, in which case the screen may be used for a button to provide the reaction.

As mentioned, the catalog items are shown or played briefly as media items and are thus limited to products or media items, which are screen-suitable for online transmission and viewing or playing in such a format. Thus images or short audio or video clips are suitable.

As shown in FIG. 3, the closed catalog may be stored on a server or on the cloud. In greater detail, the present embodiments describe a method for producing market surveys assuming the Song Map method referred to hereinabove is used for generating recommendations. The modifications needed if one wants to use another recommendation method are clear to the skilled person, which is to say, product ratings are compared to the catalog ratings to produce a pseudo-distance and then the pseudo-distances are used to assign to each individual panelist a personal pseudo-rating to the product.

### Surveying by Predictions

An idea of the present embodiments is to replace the reactions of the panel members presented with a product by predictions about their reaction to the product as computed by a recommendation technique. A method of producing predictions that would be suitable for this purpose is described in Section 10—Analytics—of provisional U.S. patent application No. 61/775,506 filed on Mar. 10, 2013, and also found in Section [0096]—Analytics—of U.S. patent application Ser. No. 14/202,093 filed Mar. 10, 2014.

The present disclosure adds new features to the method as previously disclosed. The process uses two different groups of persons whose reactions to certain stimuli are recorded. The first group is a group of panelists. Panelists were used in the previous disclosures mentioned above, and the panelists are a large representative group of the target population. To give two examples, a representative group of 3000 panelists from the U.S. and a group of 2,700 panelists from Belgium have been used in different operations. These numbers are large enough that even relatively small sub-groups such as males between the ages of 20 and 35 still have statistically significant representation.

The second group of persons is a group of raters, also called a focus group. This is a much smaller group, from 30 to 60 people, typically, that may contain people of varied age, gender, background, and so on, but has the unique feature that it is not representative of the target population.

The process comprises the following stages that need not be performed in exactly this order.

1. Building a catalog of pictures and/or videos, and/or audio files suitable for gathering taste information from panelists and raters. Taste information is typically gathered by asking the panelists and the raters to rate the item presented, picture, video or audio, on a predefined scale such as 1 to 5, 1 to 3, or yes-no.

2. Gathering a panel and obtaining demographic and taste information about its members. Taste information may be gathered only on a small sample of the catalog chosen at random for each panelist, or panelists can be shown the entire panel, as desired for statistical ruggedness.

3. Building a focus group of people (raters), typically much smaller than the panel, to rate the catalog in its entirety.

4. Uploading a new product, or a new presentation of a product, or a media item, on a website. A product is typically presented by a picture and a legend, but may be a video clip with or without legend, or an audio clip, or a picture without any legend.

5. Requiring raters of the focus group to rate, on a predefined scale, the new product.

6. Computing a distance between the product and each of the catalog items on the basis of the ratings given by the raters of the focus group.

7. Computing, for each panel member, a prediction about how he/she would have rated the new product on the basis of his/her reaction to the items of the catalog that have been presented to him/her and the distance computed between the product and the catalog items.

8. Computing aggregates of the predictions concerning the product, over the panel members.

9. Presenting those aggregates and marketing hints to a client on a web site.

An advantage of the technique of the present embodiment is that, once the panel has been gathered and the taste and demographics of its members elicited, the information obtained may be used and reused without limitation and without any additional effort for many different future products to be considered, since the panel members need not be aware of the product. It is noted that, instead of statistics about panel members reactions, the pseudo-ratings are statistics about predictions of panel members reactions, and therefore a certain margin of error is introduced. Experimental results on the evaluation of this error can be found hereinbelow.

An advantage of the present embodiments is that the time required by the process from the availability of a new product until aggregates are presented is much shorter than with the existing art since only the smaller group of raters has to react to the product.

### Building a Catalog

A catalog of items may be carefully chosen so that the immediate reaction, attraction or repulsion, of a panelist or a rater to the presentation of the item reveals some traits of his/her deeper personality. The present inventor experimented only with pictures and videos (musical and movies) but other types of items may be chosen. There follows the list of categories of items that the present inventor experimented with, but many other categories can be used: people, human faces, animals, plants, food, architecture, urban landscapes, country landscapes, pictures of everyday life, pictorial art, plastic art, artistic photography, jewelry, bags, fashion clothes and accessories, computer games, music, movies. Products of reference, similar to the products to be marketed, may also be part of the catalog. An embodiment may be realized by an on-line presentation of the items through the Internet. In such a case, the catalog items must be such that they can be fully evaluated on-line: pictures, audio clips and video clips are perfect for this purpose, text can be used but requires more time to be evaluated by panelists and raters, and fragrances are not suitable. Such items are referred to generally herein as being screen-suitable and the use of the term “screen-suitable” is intended to include audio clips.

The catalog is presented in its entirety to the raters and part of the catalog may be presented to each of the panelists. The items presented to each panelist may be different, even chosen randomly. The catalog must be large enough to elicit responses related to the many facets of human personality.

In the experiments of the present inventor, he used a catalog of 518 items. As explained just above each rater was presented with each of the 518 items but each panelist was presented with only 50 of the catalog items, drawn at random independently for each panelist.

When presented with a catalog item, both panelists and raters are requested to react in the most instinctive and immediate way to the item, indicating whether they like it or not, or whether they are attracted to it or repelled by it. The exact wording of the question is not crucial, but the formulation must be the same for all items (and for the products presented to the raters) and the same for panelists and raters. In an on-line embodiment, panelists and raters may be required to rate items on a predefined scale (1 to 5 for example) or to swipe the item in one direction to indicate they like it and in another direction to indicate they do not like it. It is commonly accepted that a right-swipe expresses attraction and a left-swipe rejection.

### Gathering Taste and Demographic Information from a Large Panel

One gathers panelists who answer personal questions and provide individual reactions to each of the catalog items. The catalog is chosen in such a way as to ensure that the panelists reactions to its items express the panelist's individual taste, taken in the most general sense. The personal questions must include all demographic information for which aggregates may then be provided to the users such as, but not limited to: gender, age, location, language spoken, education, field of studies, employment status, occupation, income, ethnicity, marital status, hobbies, possession of appliances, in particular electronic appliances, usage of social networks, type of computer, religion, shopping habits, interests, opinions on specific brands and so on. Such information may be used to present the user, for example, with information such as: your product A is twice as popular amongst tennis players as amongst golfers, or your product A is definitely more popular than your product B among females but they are appreciated in a similar way by males.

The larger the panel, the more reliable are the aggregates obtained. A common rule of thumb is that no reliable statistical information can be obtained from less than 32 data points. Therefore, one should aim at gathering at least this number of panelists in each of the demographic categories to be surveyed: 32 golfers and 32 tennis players, for the example above. If one is interested in comparing the success of products in the different states in the U.S.A., one should aim at such a number of panelists in each state of the union. The experiments of the present inventor were conducted with between 2,000 and 3,000 panelists. As explained above, an advantage of the method of the present embodiments is that the same panelists answers will be used over and over again to provide predictions about an unlimited number of different products. The consultation of the panel is performed once and for all, and therefore it is not difficult or expensive to gather a very large panel, comprising tens of thousands of panelists. Such a large panel is, without much effort, representative of many target populations.

Organizing such a large panel can be particularly easy and inexpensively carried out over the Internet, and one may make use of one of many companies that organize on-line panels.

### Focus Group

The second sample, now referred to as a focus group, is gathered, and we refer to its members hereinbelow as raters. Contrary to the panel, the focus group is a permanent fixture of the process, that must be available every time a new market survey is prepared. Its task is to evaluate each of the items of the catalog and also each of the new products for which a market survey has to be produced. Raters evaluate the catalog items and the new products in a way that mimics the way panelists do. But, because of the repeated need to consult them for every new market survey to be provided, they may perform their job through a proprietary system rather than through an outside company.

The ratings of the focus group are used to compute the proximity of different items between themselves and with new products, according to the SongMap method described in U.S. Pat. Nos. 7,075,000 and 7,102,067, as incorporated herein by reference. No individual demographic information need be collected on the focus group members and they need not be representative of the target population. But they should be diverse enough to provide different points of view on the relative proximity of the different catalog items and the products of interest.

The larger the focus group the better, but a group of 30 to 40 members seems to be sufficient to give usable results.

### Uploading a New Product

When someone interested in putting a product on the market requests a market survey for that product, the system initially requires a presentation of the product. The presentation is forwarded to the members of the focus group who will, then, rate them as they rated the catalog items. An embodiment consists of a web site to which a user can upload pictures, videos or other material.

### Computing Distances

The ratings given by the members of the focus group enable the computation of a distance, more precisely a pseudo-distance, between a product and each of the catalog items, in the manner described in the SongMap method of the patents mentioned above.

### Computing Predictions

For each of the panelists, the recommendation algorithm as discussed herein may be used to compute a quantity measuring how much the panelist is predicted to like, i.e., react positively, to the new product being tested and to each of the items of the catalog. This quantity is computed on the basis of the ratings given by the panelist to the catalog items he/she rated and the distances whose computation is described herein. We refer to this quantity as the appreciation factor of the catalog item for the panelist. Meaningful aggregates of the appreciation factor can be computed over subpopulations of panelists.

### Presentation of Results

For a new product, the user is presented with different aggregates of the appreciation factor computed as discussed hereinabove, for many different subpopulations of panelists. Each of the demographic pieces of information requested from the panelists can be the basis for defining a subpopulation. Here are examples of subpopulations of interest: females, people of age 45-54, residents of California, residents of Japan, people working in the health industry, golfers, Afro-Americans, speakers of Spanish, and so on. Any conjunction, disjunction or negation of such information pieces can also be used to define a subpopulation: e.g., residents of Illinois, Indiana and Michigan of age 18-25.

There are two main types of aggregates that are presented in a market survey for a given product. The first type is the average value, over the panelists in the subpopulation chosen, of the normalized quantity described hereinbelow. The average value measures the overall popularity of a product among a given subpopulation. The technology provides an unscaled number measuring this attraction. A linear transformation is used to ensure that the aggregate, or average, for a product typically falls in the range zero to one hundred. The number obtained is called the rank of the product for the given subpopulation. Only exceptionally are such ranks negative or larger than 100. A product whose rank is close to 100 is extremely popular, and a product whose average is closed to zero is very unpopular. The second, more refined, type of aggregate describes the distribution of the population amongst levels of popularity. One may, for example, choose three levels: like, indifferent and dislike, and measure the percentage of people in the population considered that place a product in the first third, the middle third or the last third of the catalog items ordered by the panelist's appreciation factors. For example, it may be the case that 15% of males like a product, 10% dislike it and 75% are indifferent to it, but 40% of females like it, 35% dislike it and 15% are indifferent to it.

### Error Evaluation

Since the technology does not present the products of interest to the members of the panel but computes a prediction about the reaction of each of the members of the panel, it introduces a systematic error. This error is the error made by the technology in evaluating the sample member's reaction instead of measuring it directly. This error cannot be evaluated theoretically since its causes are unknown. It can only be evaluated experimentally by comparing predictions to numbers extracted from the panelists themselves.

Such a test and its conclusions are presented below.

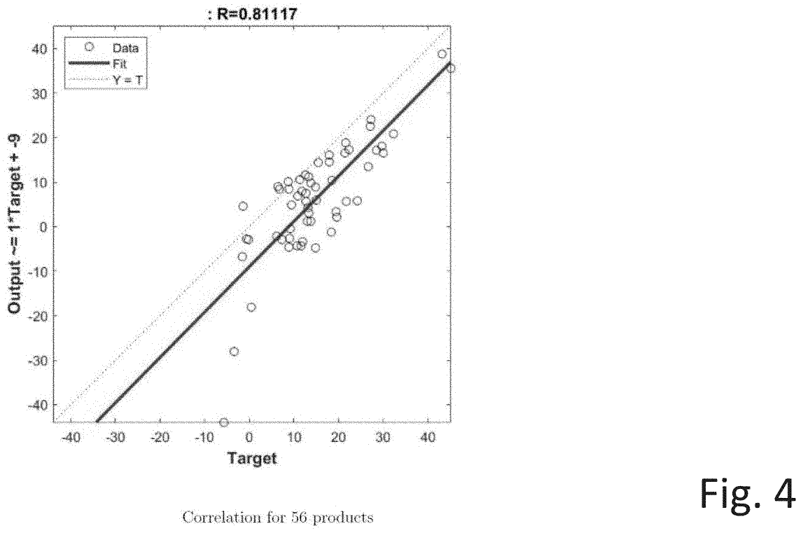

In November 2018, a group of about 2500 panelists in the U.S.A. was gathered. They were chosen to be a representative sample of the U.S. population. Each of those panelists was asked to indicate, on a scale of 5 grades, his or her attraction to each of 55 products. Independently, a prediction of such attraction has been computed using the technology. The correlation between prediction and measured rating is described in FIG. 4.

A significant question is the following: if the rank obtained by product A is higher than that of product B and the difference in ranks is x, how high is our confidence in the fact that A is indeed more attractive than B?

An answer is provided below.

Considering each of the 1,485 pairs of different products, one can evaluate how well the of the two products predict the product that is in fact preferred by the population.

Here are the results.

If the rank of product A is larger or equal to that of product B, there is a 78% chance that A is indeed preferred to B.

If the difference in ranks is at least 1, the chances are 80%.

If the difference is at least 5, the chances are 85%.

If the difference is at least 10, the chances are 90%.

If the difference is at least 20, the chances are 96%.

### Additional Embodiments

The method described in this application can also be used to produce market surveys for a family of related products, for comparing different possible designs for a product, or for comparing different competing products.

By analyzing the aggregates provided for a product, the method can propose and evaluate different market plans by characterizing the subpopulation best responding to the product and different larger populations.

By comparing the popularity of a new product with already known products, the method can also provide a list of products that fared the way the new product does, enabling the user to gain precious knowledge about the potential success of his product.

The embodiments are now considered in greater detail.

### AM-Ranks

An embodiment of the present invention may receive a visual presentation of a product and may produce a number, its AM-rank, that measures the immediate attraction of the product's presentation on potential customers. AM-ranks are computed for different products or different presentations of a product and for different segments of a population defined by demographic parameters such as: gender, age, income, location, shopping habits, children and so on.

### Panelists

As discussed above, a panel is formed by gathering, on the internet, typically a few thousand people representative of the population of interest. Those panelists are required to answer demographic questions and to rate on a scale of 1 to 5 around 60 pictures or videos that have been selected as described above. Those items constitute the catalog. As discussed above, the items may have been chosen to evoke in our panelists deep emotions and an immediate reaction of attraction or repulsion, based on system 1 reactions as per the categorization used by Daniel Kahneman in his book Thinking Fast, Thinking Slow.

Examples of possible catalog items are: people, countryside and urban landscapes, animals, works of art, fashion items and so on. Note that the products to be assessed are not shown to the panelists. For one test, the present inventor recruited a panel of 2,824 panelists from the U.S. population.

### Recommendations

An idea of the present embodiments is to replace the reactions of the panel members presented with a product by predictions about their reaction to the product, had they been presented with the product, computed by a recommendation technique. Recommendation engines, such as Apple's genius, Amazon's, Netflix's, Google's or Facebook's systems are very successful at predicting the appeal an item may have for an individual. Each of them is adapted to its specific domain and they use different sorts of information on the individual to generate recommendations. The present embodiments however use a recommendation technique that the present inventor developed for the musical domain twenty years ago, and which are now adapted to the present task. It is a pure item-to-item recommendation engine, in contrast to the engines mentioned above that may use some item-to-item features but always in cooperation with other techniques. The present embodiments need not use any demographic information about the individual to whom the recommendation is addressed. It uses only the ratings of the items of the catalog, the ratings being provided by the individual.

To provide recommendations to each panelist we gather a group of raters, also called a focus group. This is a much smaller group (from 30 to 60 people typically), that must contain people of varied age, gender, background, and so on, but need not be representative of the target population. The raters are required to rate the catalog items and the products to be appraised. As mentioned above, those ratings enable us to compute a pseudo-distance between each product and each of the catalog items. A product and an item that have received ratings that are close to each other, on average, have a small pseudo-distance, and conversely a product and an item that receive very different ratings are given a large pseudo-distance.

A weighted average of the ratings of the catalog items by a panelist measures the attraction exerted by a product on the panelist, wherein the weights are in an inverse relation to the pseudo-distances.

### Aggregates

Once every pair of a panelist and a product has been associated with a number measuring the predicted attraction of the panelist for the product, the AM-rank of a product for a subpopulation of raters with given demographic characteristics is computed as a normalized average of those numbers over all the panelists in the subpopulation.

### Comparing the Attraction of Two Products

The following deals with the reliability of the AM-ranks in predicting the success of a product among a given subpopulation. Let us again consider the following question: given two products, or two different presentations of a product, how well does the difference in their respective AM ranks predict their relative appeal to the population concerned? In short: if product A has an AM-rank larger than that of product B, how much confidence do we have that A is going to be more successful than B?

### Two Preliminary Remarks

First, the answer to the question above depends on what is meant by “successful”. AM's technology evaluates the immediate attraction that a product provokes among a random sample of the population of interest. If “successful” means attractive, the analysis below is totally relevant, but if it means something else, like sales or profit, then it is clear that attraction is only one of many factors to be considered.

Secondly, assuming we are interested in evaluating immediate attraction, the confidence we can have in our evaluation (the AM rank) depends on two parameters:

1. the size of our sample population (the larger the sample the better) and,

2. the quality of AM's AI technology that predicts the reaction of each panelist to a stimulus that the panelist has not seen on the basis of his reactions to stimuli previously presented.

### Two Types of Errors

To relate the difference in AM ranks of two products to their relative attraction we, therefore, have to assess two different types of errors as follows:

1. an error due to the limited size of our sample of panelists: for example we have only 2,824 panelists to represent the population of the U.S.A., and

2. the error made by our AI technology that replaces a direct question to a panelist by a computation.

The first kind is a random error, let us call it the sampling error and depends on the size of our sample population. There are well known statistical methods to evaluate it. The second kind is a systematic error, let us call it the technological error and it can only be evaluated by an experiment.

It is clear that the confidence we can have in our prediction that a product with high AM rank will be more successful than a product with a lower AM rank is higher if the number of panelists in the sample is larger and if the difference between the two AM ranks is larger. The below provides an in-depth analysis of those two kinds of errors and sets precise degrees of confidence. Note that the two errors are independent and it follows, as we shall see, that in almost all situations one of the errors is negligible with respect to the other. More particularly, for small populations the sampling error is dominant, for large populations the sampling error is negligible.

### The Sampling Error

The evaluation of the sampling error is a textbook exercise. The difference in the AM ranks of two products for a given population needed to ensure a 95% certainty depends only on the size of the population and on the standard deviation of the signal for the two products with respect to this population. A study of those standard deviations shows that they do not significantly differ from one product to another product and that they do not significantly vary with the size of the population concerned. The average standard deviation of the signal for P&G products and for any population size has been computed at s=38:69. The difference d in AM ranks that gives a 95% certainty with respect to a sample population of size N is therefore given by:

$$d = t ( 2 ( N - 1 ) ) X \sqrt{\frac{2 {S}^{2}}{N}}$$

where the function t(n) is the Student t-distribution for n degrees of freedom. For N=2000, one has

$$d = 1 \text{:} 960 * \sqrt{\frac{2 * 1 , 496.92}{2 , 000}} = 2.4 \; 0 .$$

### For N=500, one has

$$d = 1.960 * \sqrt{\frac{2 * 1.496 .92}{500} = 1.960} .$$

### For N=100, one has

$$d = 1 \text{:} 980 * \sqrt{\frac{2 * 1 , 496.92}{100}} = 10.83 .$$

### For N=50, one has

$$d = 1.984 * \sqrt{\frac{2 * 1.496 .92}{50} = 15.35} .$$

### The Technological Error

The present embodiments use a sample of the population of interest, but does not present the products of interest to the members of the sample. It computes a prediction about the reaction of each of the members of the sample: it predicts how much a member would be attracted to the product if the product had been presented to her or to him. This introduces a new kind of error, the technological error. The technological error is the error made by AM's technology by evaluating the sample member's reaction instead of measuring it directly. This error cannot be evaluated theoretically since we do not know its causes, as mentioned above. It can only be evaluated experimentally by comparing AM's predictions to numbers extracted from the panelists themselves. Such a test and its conclusions are presented below, but one should bear in mind that this test was performed not on products actually the subject of the survey, but on a different product and not on the pool of panelists gathered for the prototype survey but on another pool of U.S. panelists.

### A Test

As discussed above, a group of about 2500 panelists in the U.S.A. were recruited as discussed above. They were chosen to be a representative sample of the U.S. population. Each of those panelists was asked to indicate, on a scale of 1 to 5, his or her attraction to each of 55 products. Independently, a prediction of such attraction had been computed using AM's technology as explained in the first part of this brief.

We computed, for each panelist, the correlation between the 55 numbers measuring the predicted panelist's attraction to each product and the 55 ratings he gave to each product. The average of those 2500 correlations is 0.3: a weak but significant correlation. We also computed the correlation between the 55 average predicted attractions and the 55 average ratings and the graph is presented in FIG. 4 as discussed above. The correlation of 0.81 shows a high correlation, allowing a conclusion that the information given by the AM-rank of a product is reliable.

Let us now consider the comparison between two products. Considering each of the 1,485 pairs of different products, one can evaluate how well the AM ranks of the two products predict the product that is in fact preferred by the population. The results are the same percentages given above.

If the AM rank of product A is larger or equal to that of product B, the chances are 78% that A is indeed preferred to B.

If the difference in AM ranks is at least 1, the chances are 80%, and may extend to 96% if the difference is 20.

It is noted that the technological error does not seem to depend on the size of the sample, at least for reasonably large samples.

### CONCLUSION

One sees that: if one looks for a 95% certainty one should look for differences in AM ranks that are at least 20, and this will provide a 95% certainty even for populations of the order of 50 panelists. A 90% certainty can be obtained with a difference of 10, but only for populations of a size at least about 120.

### Some More Detailed Embodiments

The above describes a way to predict the attraction individual products exert on different segments of a population, thus enabling a comparison between individual products. We now describe how such predictions can be used to provide answers to other business-related questions.

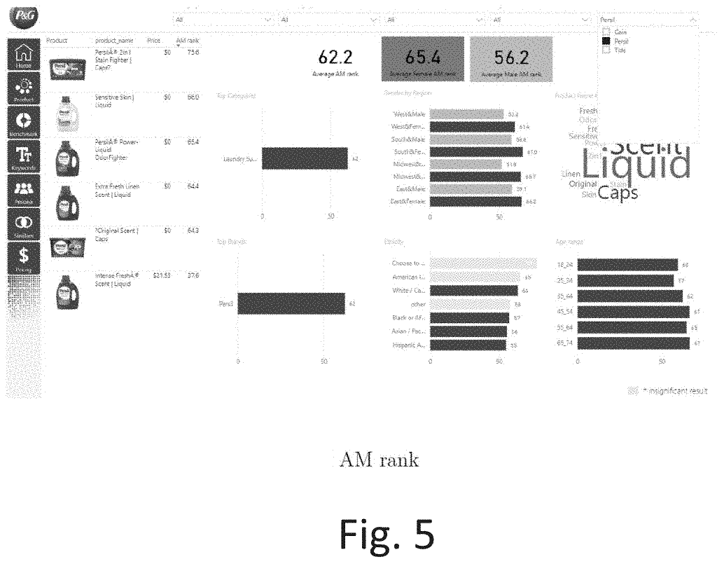

1. Often one seeks to predict the attraction of a group of individual items, for example a brand and, perhaps, compare it with other brands. This can be done by computing the average appreciation factor of the products of the group, or the brand. FIG. 5 shows the appreciation factor (AM rank) of Persil™ products.

As explained above, the panelists are asked personal questions, such as their age or how many children they have, or many other questions which could be relevant to a client in his/her business decisions. So far, when we mentioned the attraction of a product on a segment of the population, we meant the panelists who answered in a certain way to a certain question, e.g. panelists with 3 or more children, or panelists between 25 and 34 years of age. But one can compute the attraction of a product on any segment of the population that is precisely defined in terms of the questions asked from the panelists. For example, if one is interested in predicting the attraction of a product to a population of age between 35 and 54 comprised of 70% women and 30% men one can do so by computing the suitable weighted average over the appreciation factors obtained by the product among women of age 35 to 54 and men of the same age.

In certain circumstances, one would like to know which are the products that attract the same people as a given product: for example, to decide which products to present on a shelf with a given product. One may harness our prediction engine in order to achieve this goal. Since the engine produces an appreciation factor for every product and every segment of the panelists population, every product corresponds to a vector of such factors. One may measure the similarity of two products by the correlation between the two vectors of appreciation factors corresponding to each of the products. The products that attract the same segments of the panelists as a given product are those presenting the highest correlation with the given product. FIG. 6 is an example in which use of the present embodiments provides four products that attract the same population segment, as indicated by panelists, as the selected product.

In order to find the best way to sell a product it is useful to describe the profile of the people most likely to be attracted to the product, often called the persona of the product. A prediction engine according to the present embodiments allows one to find the persona of a product, or a group of products in the following way. In short, use of the present embodiments may find all panelists who showed a strong attraction to the product, or a group of products, and, for each segment of the panelists population (a segment is the set of panelists who gave the same answer to a given question) the embodiments may compute the proportion of those panelists who showed strong attraction to the product. The segments for which a high proportion of panelists are strongly attracted to the product are the defining features of the persona. For example, if we find that a higher proportion of males than of females is strongly attracted to the product we may build a male persona for that product.

In doing so, one should pay attention to the following:

The span of the appreciation factors for a given panelist over the different products may vary in an extreme way as compared to other panelists, so that some panelists give low appreciation factors and some give high appreciation factors. Therefore to decide if a panelist is strongly attracted to a product, one cannot consider only the appreciation factor that the panelist gives the product, one must consider how this factor fits in the overall distribution of appreciation factors for the panelist.

The different panelist segments have different biases: some segments tend to present higher appreciation factors, on average, than others. For example, women tend to produce higher appreciation factors than men. Therefore, in building a persona, one must normalize for this feature.

Since some products are more popular than others, but one wants to base the persona of each product on a large enough group of panelists, one needs to normalize for this feature also.

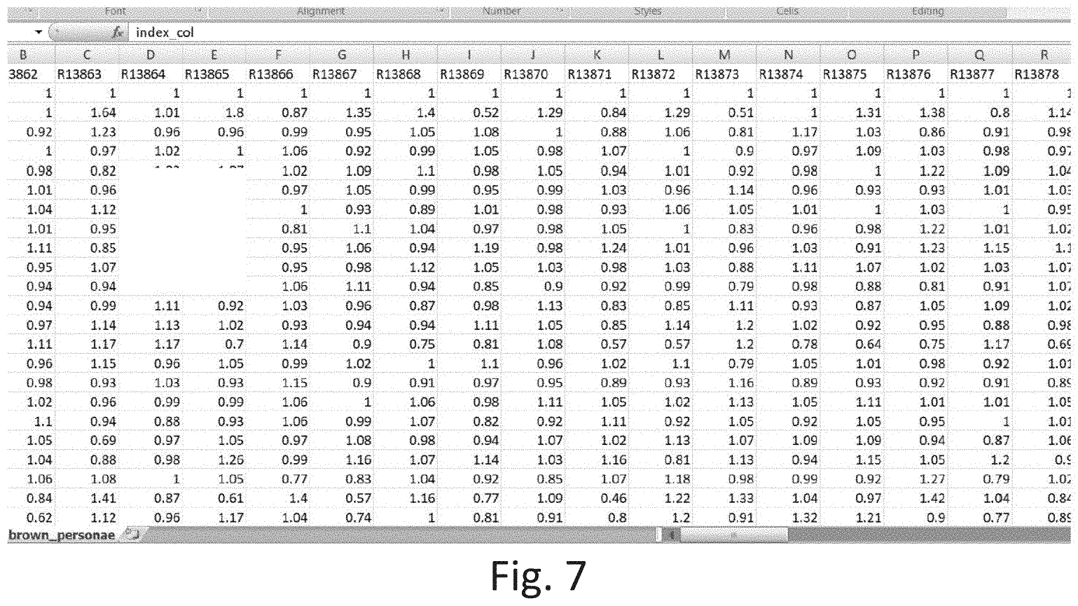

FIG. 7 presents part of a table describing personality features for a number of products. Each column corresponds to a product and each row corresponds to a segment of the panelists population.

All numbers larger than 1 indicate that the segment in the row is attracted to the product in the column more than expected.

A value higher than 1.2 expresses a feature that is part of the persona of the product.

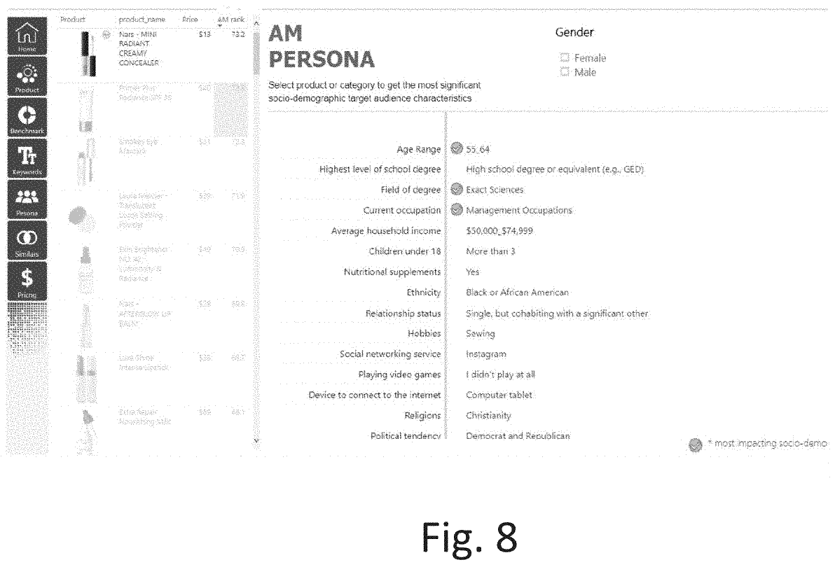

FIG. 8 presents the personality who would be interested in a beauty product.

In this disclosure, the terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of remote surveying to forecast popularity of a product or a media item comprising:
Electronically generating a closed catalog of items, said items being products or media items, the items being stored as files in electronic media;
Over a network, obtaining a first sample of people that are representative of a population and statistically significant;
Electronically sending to each person of said first sample at least some of said files, and showing or playing said files for a predetermined interval at a terminal device of each said person of said first sample;
Electronically obtaining from each person of said first sample a rating of each catalog item shown or played;
Electronically storing said ratings;
Over said network obtaining a second sample of people, said second sample being smaller than said first sample such that said second sample is not representative of said population;
Electronically sending to persons of said second sample files representative of said product or media item whose forecast is required along with respective files of said items of said catalog and showing said files on a respective terminal device for said predetermined amount of time;
Electronically obtaining from each person of said second sample ratings of said product or media item and of each catalog item;
From said second sample, calculating a pseudo-distance between respective catalog items and said product or media item;
Using said pseudo-distance, applying to each person of said first sample a personal pseudo-rating for said product or media item, and
Outputting said personal pseudo-ratings as a statistically significant electronic indicator of reactions to said product or media item.

2. The method of claim 1, further comprising:
Aggregating said personal pseudo-ratings to obtain an aggregated rating for said product or media item, the aggregated rating thereby having statistical significance; and
Outputting said aggregated rating as an electronically derived product rating.

3. The method of claim 1, further comprising applying clustering to persons of said first sample based on said pseudo-ratings and profile information of said persons to obtain a generalized profile of one member of the group comprising: persons in approval of said product and persons not in approval of said product.

4. The method of claim 1, wherein said electronically showing is carried out using an electronic screen, said product or media item being shown on said screen for said predetermined amount of time followed by an interval for receiving a rating.

5. The method of claim 1, wherein each person of said first sample is shown a random selection of items of said catalog, and each person of said second sample is shown all of the items of said catalog.

6. The method of claim 1, wherein said catalog is limited to products or media items which are screen-suitable for online viewing.

7. The method of claim 1, comprising storing said closed catalog on a server and carrying said electronically showing and electronically obtaining from at least some of said people of said second sample via respective mobile telephones.

8. The method of claim 1, comprising storing said closed catalog on a server and carrying said electronically showing and electronically obtaining from at least some of said people of said first sample via respective mobile telephones.

9. The method of claim 1, comprising providing forecasts for a plurality of additional products or media items and then grouping said products according to similarities in respective generalized profiles.

10. The method of claim 1, further comprising normalizing ratings of different persons of said first sample.

11. The method of claim 1, wherein said files of said catalog items are sent individually over said network for said showing.

12. The method of claim 1, wherein said files of said catalog items are streamed over said network for said showing.

13. The method of claim 1, comprising uploading electronic media relating to said product whose forecast is required over said network.

14. The method of claim 1, being cloud-based.

15. The method of claim 1, being server-based.

16. The method of claim 1, wherein respective terminal devices of said second sample are mobile devices with location ability, the second sample being selected according to a currently obtained location.

17. The method of claim 1, comprising aggregating results for a set of products.

18. An application for use at respective terminal devices configured for use with a method of remote surveying to forecast popularity of a product or a media item, the method comprising:
Electronically generating a closed catalog of items, said items being products or media items, the items being stored as files in electronic media;
Over a network, obtaining a first sample of people that are representative of a population and statistically significant;
Electronically sending to each person of said first sample at least some of said files, and showing or playing said files for a predetermined interval at a terminal device of each said person of said first sample;
Electronically obtaining from each person of said first sample a rating of each catalog item shown or played;
Electronically storing said ratings;
Over said network obtaining a second sample of people, said second sample being smaller than said first sample such that said second sample is not representative of said population;
Electronically sending to persons of said second sample files representative of said product or media item whose forecast is required along with respective files of said items of said catalog and showing said files on a respective terminal device for said predetermined amount of time;
Electronically obtaining from each person of said second sample ratings of said product or media item and of each catalog item;
From said second sample, calculating a pseudo-distance between respective catalog items and said product or media item;
Using said pseudo-distance, applying to each person of said first sample a personal pseudo-rating for said product or media item, and
Outputting said personal pseudo-ratings as a statistically significant electronic indicator of reactions to said product or media item;
the application interacting with said method to carry out said showing or playing said files for a predetermined interval at said terminal device and electronically obtaining corresponding ratings.

19. A server for use in a method of remote surveying to forecast popularity of a product or a media item, the method comprising:
Electronically generating a closed catalog of items, said items being products or media items, the items being stored as files in electronic media;
Over a network, obtaining a first sample of people that are representative of a population and statistically significant;
Electronically sending to each person of said first sample at least some of said files, and showing or playing said files for a predetermined interval at a terminal device of each said person of said first sample;
Electronically obtaining from each person of said first sample a rating of each catalog item shown or played;
Electronically storing said ratings;
Over said network obtaining a second sample of people, said second sample being smaller than said first sample such that said second sample is not representative of said population;
Electronically sending to persons of said second sample files representative of said product or media item whose forecast is required along with respective files of said items of said catalog and showing said files on a respective terminal device for said predetermined amount of time;
Electronically obtaining from each person of said second sample ratings of said product or media item and of each catalog item;
From said second sample, calculating a pseudo-distance between respective catalog items and said product or media item;
Using said pseudo-distance, applying to each person of said first sample a personal pseudo-rating for said product or media item, and
Outputting said personal pseudo-ratings as a statistically significant electronic indicator of reactions to said product or media item;
the server configured to store said catalog, send data of said catalog to said first sample, and to send data of said catalog and said product or media item to said second sample, to receive respective ratings, to calculate respective pseudo-distances and provide said output.
